(19) United States
(12) Patent Application Publication
(10) Pub. No.: US 2016/0247464 A1
(43) Pub. Date: Aug. 25, 2016

(54) BACKLIGHT MODULE, DISPLAY DEVICE AND DRIVING METHOD THEREOF

(71) Applicant: SHENZHEN CHINA STAR OPTOELECTRONICS TECHNOLOGY CO. , LTD., Guangdong (CN)

(72) Inventors: Chih tsung KANG, Shenzhen (CN); Yong FAN, Shenzhen (CN)

(21) Appl. No.: 14/380,900

(22) PCT Filed: May 14, 2014
(86) PCT No.: PCT/CN2014/077478

§ 371 Date: Aug. 25, 2014

(30) Foreign Application Priority Data
May 8, 2014 (CN) 201410193769.X

(51) Int. Cl. G09G 3/36; G02F 1/1335; F21V 9/16; G09G 3/34; F21V 8/00

(52) U.S. Cl. CPC G09G 3/3607; G09G 3/3413; G02B 6/0068; G02B 6/0023; F21V 9/16; G02F 1/133611; G02F 1/133609; G02F 1/133514; G09G 2320/0242

(57) ABSTRACT

The present disclosure relates to the technical field of display, and provides a backlight module, a display device and a driving method thereof, for solving the technical problem that an existing FSC liquid crystal display may have a color break up phenomenon. The backlight module includes a first color light source, a second color light source, and third color fluorescent powder arranged around the first color light source or the second color light source, wherein, the energy level of the first color or the second color is higher than that of the third color. The display device includes a liquid crystal module and the above backlight module. The present disclosure may be used in a liquid crystal television, a liquid crystal display, a mobile phone, a flat panel computer and the like.

### FIELD OF THE INVENTION

The present disclosure relates to the technical field of display, in particular to a backlight module, a display device and a driving method thereof.

### BACKGROUND OF THE INVENTION

With the development of display technology, liquid crystal display (LCD) has become the most common flat panel display device. In one kind of liquid crystal displays which can display images through field sequential color (FSC), no filter layers of red, green and blue are necessary, so that the loss of light may be reduced, and the utilization rate of a backlight source may be improved.

In the existing FSC liquid crystal display, images are displayed according to the following principle. That is, each frame of image is divided into three color fields displayed in sequence. In the first color field, the backlight module only emits red light, and a liquid crystal module is driven to display the red part of the frame of image; in the second color field, the backlight module only emits green light, and the liquid crystal module is driven to display the green part of the frame of image; and in the third color field, the backlight module only emits blue light, and the liquid crystal module is driven to display the blue part of the frame of image. When the three color fields are seen sequentially, they can be combined into the frame of image at human eyes.

However, the existing FSC liquid crystal display at least suffers from the following technical problems. During the display process, if a relative movement is generated between the human eyes and the FSC liquid crystal display, then the three color fields sequentially seen by the human eyes will be located on different positions in the human eyes. Therefore, the red part, green part and blue part of the frame of image will be combined in a dislocated manner, thus forming a distorted image. Namely, a color break up phenomenon occurs.

### SUMMARY OF THE INVENTION

The present disclosure aims to provide a backlight module, a display device and a driving method thereof, for solving the technical problem that an existing FSC liquid crystal display may have a color break up phenomenon.

The backlight module according to the present disclosure includes a first color light source, a second color light source, and third color fluorescent powder arranged around the first color light source or the second color light source, wherein the energy level of the first color or the second color is higher than that of the third color.

Preferably, the first color light source is a red light source, the second color light source is a blue light source, and the third color fluorescent powder is green fluorescent powder arranged around the blue light source.

Preferably, the green fluorescent powder is sulfide fluorescent powder, aluminate fluorescent powder, phosphate fluorescent powder, borate fluorescent powder, silicate fluorescent powder or nitrogen oxide fluorescent powder.

Preferably, the first color light source and the second color light source may be driven independently.

In addition, the backlight module may further include a first driver connected with the first color light source, and a second driver connected with the second color light source.

Preferably, the first color light source and the second color light source are light emitting diodes (LED).

Optionally, the backlight module is a side-type backlight module or a direct-lit backlight module.

The present disclosure further provides a display device, including a liquid crystal module and a backlight module, wherein the liquid crystal module includes a plurality of pixel units, each pixel unit including a transparent sub-pixel, a green sub-pixel and a blue sub-pixel; and wherein a transparent filter layer or no filter layer is arranged in the transparent sub-pixel, a green filter layer is arranged in the green sub-pixel, and a blue filter layer is arranged in the blue sub-pixel; and wherein the backlight module includes a red light source, a blue light source, and green fluorescent powder arranged around the blue light source, the red light source and the blue light source being driven independently.

The present disclosure further provides a driving method for driving the above-mentioned display device, comprising: in a first color field, turning on the blue light source in the backlight module to drive the transparent sub-pixel, the green sub-pixel and the blue sub-pixel of each pixel unit in the liquid crystal module; and in a second color field, turning on the red light source in the backlight module to drive the transparent sub-pixel of each pixel unit in the liquid crystal module; wherein the first color field and the second color field form a frame of image displayed by the display device.

Further, in the first color field, when the blue light source in the backlight module is turned on, the red light source in the backlight module is also turned on.

The following beneficial effects can be achieved according to the present disclosure. The backlight module according to the present disclosure includes the first color light source, the second color light source, and the third color fluorescent powder arranged around the first color light source or the second color light source, wherein the energy level of the first color or the second color is higher than that of the third color. For example, the backlight module includes the red light source, the blue light source, and the green fluorescent powder arranged around the blue light source. The energy level of blue light is higher than that of green light, and the energy level of red light is lower than that of the green light. Therefore, when the blue light source in the backlight module according to the present disclosure emits light, the green fluorescent powder can be excited to emit green light, so that blue light and green light may be simultaneously emitted. When the red light source and the blue light source in the backlight module are simultaneously turned on, the backlight module can emit red light, blue light and green light simultaneously, which can be then synthesized into white light. Therefore, the backlight module according to the present disclosure may emit white light with the red light source and the blue light source only, and no green light source are necessary. Therefore, the power consumption of the backlight module can be reduced.

FSC display of two color fields can be realized by means of the backlight module and the display device according to the present disclosure. That is, each frame of image is divided into two color fields displayed sequentially. The working principle is that, in the first color field, the backlight module may emit white light, and the transparent sub-pixel, green sub-pixel and blue sub-pixel of each pixel unit in the liquid crystal module are driven, so that the transparent sub-pixel of each pixel unit displays the white part of the frame of image (mainly used for increasing the brightness of each pixel unit), the green sub-pixel of each pixel unit displays the green part of the frame of image, and the blue sub-pixel of each pixel unit displays the blue part of the frame of image. In the second color field, the backlight module only emits red light, and the transparent sub-pixel of each pixel unit in the liquid crystal module is driven, so that the transparent sub-pixel of each pixel unit displays the red part of the frame of image. When the two color fields are seen at human eyes sequentially, the two color fields can be combined into the frame of image.

The backlight module and the display device according to the present disclosure can realize FSC display of two color fields, i.e., display the white part, green part and blue part of the frame of image in the first color field of each frame, and display the red part of the frame of image in the second color field. Even if a color break up phenomenon occurs, the green part and the blue part displayed in the first color field are not dislocated with each other. Therefore, compared with the FSC display of three color fields in the existing FSC liquid crystal display, the technical solution according to the present disclosure can eliminate the color break up phenomenon to a certain extent.

Other features and advantages of the present disclosure will be set forth in the following description, and in part will be self-evident from the description, or be learned through implementing the present disclosure. The objectives and other advantages of the present disclosure may be achieved and obtained by structures particularly pointed out in the description, the claims and the accompanying drawings.

### BRIEF DESCRIPTION OF THE DRAWINGS

To illustrate technical solutions in the embodiments of the present disclosure or in the prior art more clearly, a brief introduction on the accompanying drawings which are needed in the description of the embodiments or the prior art is given below:

FIG. 1 is a schematic diagram of a liquid crystal module according to embodiment I of the present disclosure;

FIG. 2 is a schematic diagram of a backlight module according to embodiment I of the present disclosure;

FIG. 3a and FIG. 3b are schematic diagrams of a driving method for a display device according to embodiment I of the present disclosure; and

FIG. 4a and FIG. 4b are schematic diagrams of a driving method for a display device according to embodiment II of the present disclosure.

### DETAILED DESCRIPTION OF THE EMBODIMENTS

A detailed description of the implementation of the present disclosure will be given below, in combination with the accompanying drawings and embodiments, therefore, an implementation process of how to use technical means of the present disclosure to solve technical problems and achieve a technical effect may be fully understood and implemented accordingly. It should be noted that, as long as no conflict is generated, various embodiments of the present disclosure and various features of the embodiments may be combined with each other, and the formed technical solutions are all within the protection scope of the present disclosure.

### Embodiment I

As shown in FIG. 1, the embodiment of the present disclosure provides a liquid crystal module, consisting of an upper substrate 1, a lower substrate 2, and a liquid crystal 3, a spacer 4 and the like positioned between the upper substrate 1 and the lower substrate 2. The liquid crystal module comprises a plurality of pixel units, each pixel unit including a transparent sub-pixel T, a green sub-pixel G, and a blue sub-pixel B (only one pixel unit is shown in FIG. 1).

In this example, a transparent filter layer 5T is arranged in the transparent sub-pixel T, a green filter layer 5G is arranged in the green sub-pixel G, and a blue filter layer 5B is arranged in the blue sub-pixel B. In other examples, the transparent sub-pixel T may be provided with no filter layer therein.

The embodiment of the present disclosure further provides a backlight module, including a first color light source, a second color light source, and third color fluorescent powder arranged around the first color light source or the second color light source, wherein the energy level of the first color or the second color is higher than that of the third color.

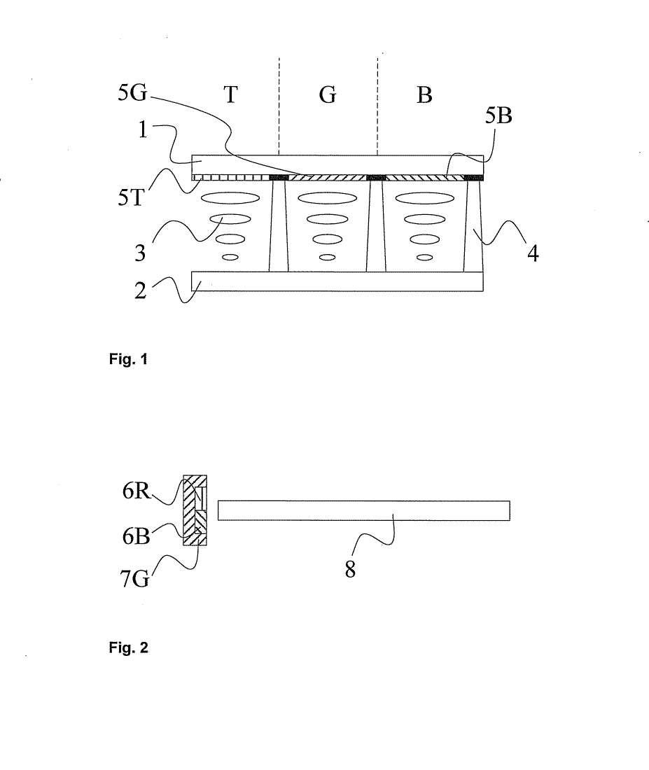

As shown in FIG. 2, as a preferred solution, in the backlight module according to the embodiment of the present disclosure, the first color light source is a red light source 6R, the second color light source is a blue light source 6B, and the third color fluorescent powder is green fluorescent powder 7G arranged around the blue light source 6B. The red light source 6R and the blue light source 6B are preferably LEDs. The green fluorescent powder 7G may be sulfide fluorescent powder, aluminate fluorescent powder, phosphate fluorescent powder, borate fluorescent powder, silicate fluorescent powder, or nitrogen oxide fluorescent powder.

In this embodiment, a side-type backlight module is taken as an example for illustration. In this case, the backlight module further includes a light guide plate 8 and other components. In other implementations, the backlight module may also be realized in the form of a straight-lit backlight module.

The energy level of blue light is higher than that of green light, and the energy level of red light is lower than that of the green light. Therefore, when the blue light source 6B in the backlight module according to this embodiment of the present disclosure emits light, the green fluorescent powder 7G can be excited to emit green light, so that blue light and green light may be simultaneously emitted. When the red light source 6R and the blue light source 6B in the backlight module are simultaneously turned on, the backlight module can emit red light, blue light and green light simultaneously, which can be then synthesized into white light. Therefore, the backlight module according to this embodiment of the present disclosure may emit white light with the red light source 6R and the blue light source 6B only, and no green light source are necessary. Therefore, the power consumption of the backlight module can be reduced.

It should be noted that, in other implementation modes, the first color light source, the second color light source and the third color fluorescent powder in the backlight module may be in other combinations of red, blue and green, and may also include yellow, cyan, and magenta or other colors, as long as the energy level of the first color or the second color is higher than that of the third color.

As a preferred solution, in the backlight module according to the embodiment of the present disclosure, the red light source 6R and the blue light source 6B may be independently driven respectively. Specifically, a first driver (not shown) connected with the red light source 6R and a second driver (not shown) connected with the blue light source 6B may be arranged in the backlight module. In this embodiment, driving chips may be used as the first driver and the second driver.

The red light source 6R and the blue light source 6B are independently driven by the first driver and the second driver respectively. When the red light source 6R and the blue light source 6B are simultaneously turned on, the backlight module can emit white light. When the blue light source 6B is turned on separately, the backlight module can emit green light and blue light. And when the red light source 6R is turned on separately, the backlight module can emit red light.

The liquid crystal module and the backlight module according to the embodiment of the present disclosure can realize FSC display of two color fields, thus eliminating the color break up phenomenon in the existing FSC liquid crystal display to a certain extent. The specific working principle of the FSC display of the two color fields will be described in detail below in combination with a display device according to the embodiment of the present disclosure.

The display device according to the embodiment of the present disclosure may be a liquid crystal television, a liquid crystal display, a mobile phone, a flat panel computer and the like, and includes the liquid crystal module and the backlight module as mentioned above.

In a driving method for the display device according to the embodiment of the present disclosure, each frame of image displayed by the display device consists of two color fields, namely FSC display of two color fields.

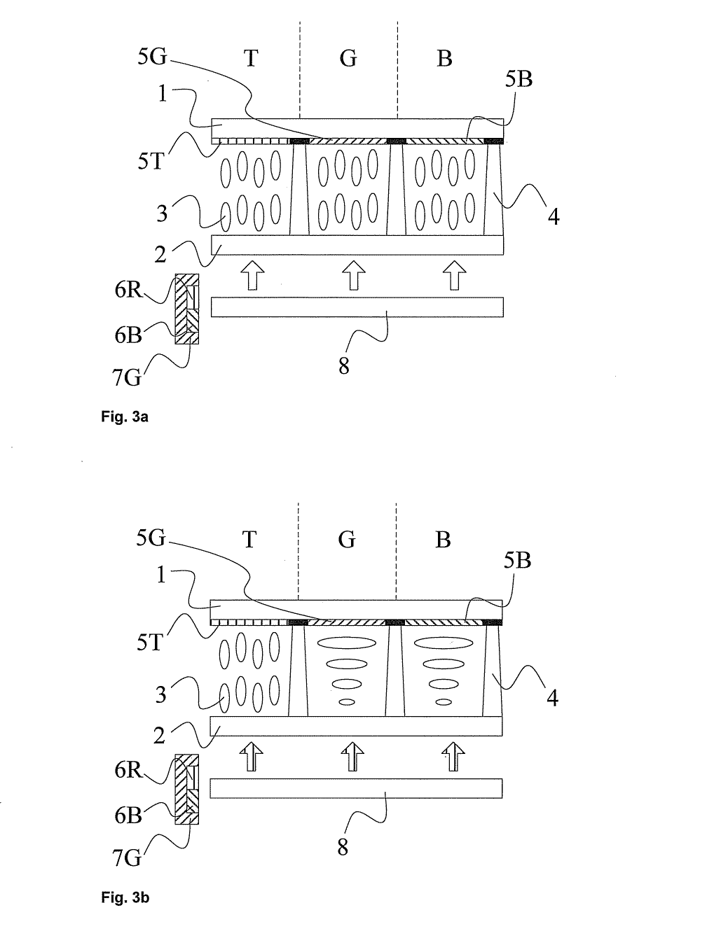

As shown in FIG. 3a, in the first color field, the red light source 6R and the blue light source 6B in the backlight module are turned on, so that the backlight module emits white light. In the first color field, the transparent sub-pixel T, the green sub-pixel G and the blue sub-pixel B of each pixel unit in the liquid crystal module are also driven, so that liquid crystals 3 in the transparent sub-pixel T, the green sub-pixel G and the blue sub-pixel B will be deflected to a certain extent. As a result, the transparent sub-pixel T of each pixel unit displays the white part of the frame of image (mainly used for increasing the brightness of each pixel unit), the green sub-pixel G of each pixel unit displays the green part of the frame of image, and the blue sub-pixel B of each pixel unit displays the blue part of the frame of image.

As shown in FIG. 3b, in the second color field, the red light source 6R in the backlight module is turned on, so that the backlight module emits red light only. In the second color field, the transparent sub-pixel T of each pixel unit in the liquid crystal module is also driven, so that liquid crystals 3 in the transparent sub-pixel T will be deflected to a certain extent. As a result, the transparent sub-pixel T of each pixel unit displays the red part of the frame of image. However, the green sub-pixel G and the blue sub-pixel B in each pixel unit are generally not driven, so that the green sub-pixel G and the blue sub-pixel B present a dark state. Of course, since the backlight module only emits the red light in the second color field, the green sub-pixel G and the blue sub-pixel B will not transmit light even if the green sub-pixel G and the blue sub-pixel B are driven.

In this case, the display device according to the embodiment of the present disclosure may display the white part, green part and blue part of the frame of image in the first color field of each frame, and display the red part of the frame of image in the second color field thereof, so as to realize a FSC display of two color fields. Even if a color break up phenomenon occurs in the display device according to the embodiment of the present disclosure, the green part and the blue part both displayed in the first color field will not be dislocated with each other. Therefore, compared with the FSC display of three color fields of the existing FSC liquid crystal display, the display device according to the embodiment of the present disclosure may eliminate the color break up phenomenon to a certain extent.

In addition, in the backlight module according to the embodiment of the present disclosure, white light can be emitted through turning on the red light source and the blue light source only. Therefore, compared with the existing backlight module consisting of a red light source, a green light source and a blue light source, the backlight module according to the embodiment of the present disclosure has lower power consumption. Moreover, in the first color field, white light may be transmitted through the transparent sub-pixel in each pixel unit, so that the utilization rate of the light cab be also improved. Further, compared with the existing light sources of three colors (red light source, green light source and blue light source), the light sources of two colors (red light source and blue light source) in this embodiment may be configured in a more compact manner, and the light of different colors may be mixed uniformly more easily. Consequently, use of light mixing components may be reduced, thus reducing the size of the whole backlight module.

On the other hand, in the existing FSC display of three color fields, each frame of image is divided into three color fields. In this case, if the liquid crystal display needs to display at the refresh rate of 60 Hz, the practical refresh rate of the liquid crystal display should reach 180 Hz. In contrast, the display device according to the embodiment of the present disclosure can realize a FSC display of two color fields, each frame of image being divided into two color fields. If the frame of image needs to be displayed at the refresh rate of 60 Hz, the practical refresh rate only needs 120 Hz.

Therefore, the display device according to the embodiment of the present disclosure has lower requirements for the refresh rate and response speed (response time) of liquid crystals, so that the display device according to the embodiment of the present disclosure is lower in cost, and may be implemented more easily in multiple patterns of in-plane switching (IPS), vertical alignment (VA), twisted nematic (TN) and the like.

It should be noted that, the sequence of the first color field and the second color field in the frame of image should be not restricted as that in this embodiment. When the frame of image is displayed, the first color field may be displayed first, and then the second color field is displayed, or alternatively, the second color field may be displayed first, and then the first color field is displayed.

### Embodiment II

The liquid crystal module, the backlight module and the display device according to this embodiment are the same as those of embodiment I, and the difference lies in that another driving method is adopted to drive the display device in this embodiment.

In the driving method for the display device according to the embodiment of the present disclosure, each frame of image displayed by the display device also consists of two color fields, namely FSC display of two color fields.

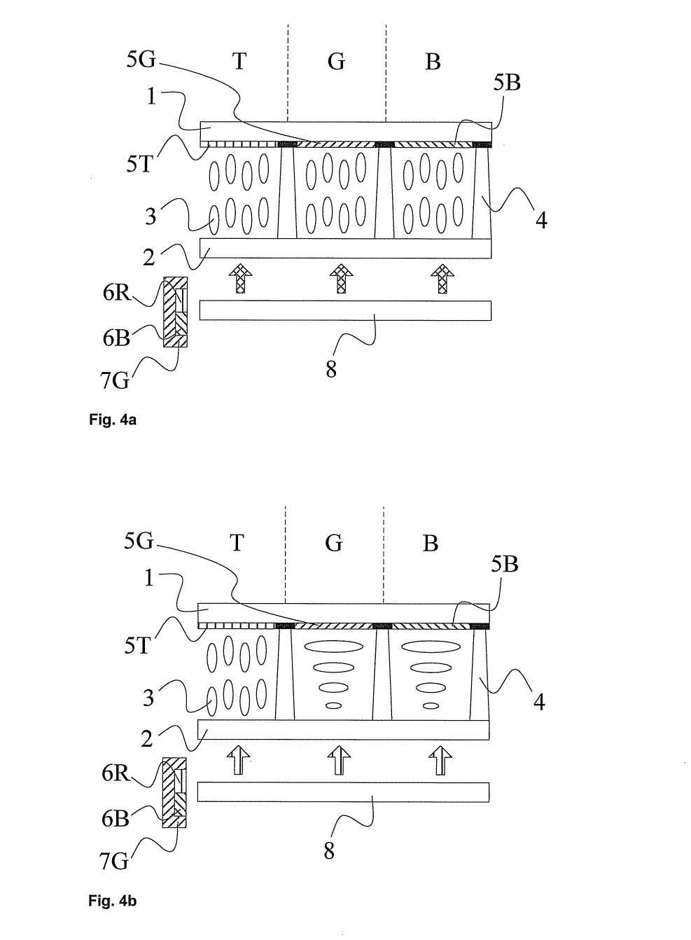

As shown in FIG. 4a, in the first color field, the blue light source 6B in the backlight module is turned on, so that the backlight module emits cyan light (consisting of blue light and green light). In the first color field, the transparent sub-pixel T, the green sub-pixel G and the blue sub-pixel B of each pixel unit in the liquid crystal module are also driven, so that liquid crystals 3 in the transparent sub-pixel T, the green sub-pixel G and the blue sub-pixel B will be deflected to a certain extent. As a result, the transparent sub-pixel T of each pixel unit displays the cyan part of the frame of image, the green sub-pixel G of each pixel unit displays the green part of the frame of image, and the blue sub-pixel B of each pixel unit displays the blue part of the frame of image.

As shown in FIG. 4b, in the second color field, the red light source 6R in the backlight module is turned on, so that the backlight module emits red light only. In the second color field, the transparent sub-pixel T of each pixel unit in the liquid crystal module is also driven, so that liquid crystals 3 in the transparent sub-pixel T will be deflected to a certain extent. As a result, the transparent sub-pixel T of each pixel unit displays the red part of the frame of image. However, the green sub-pixel G and the blue sub-pixel B in each pixel unit may be generally not driven, so that the green sub-pixel G and the blue sub-pixel B present a dark state. Of course, since the backlight module only emits the red light in the second color field, the green sub-pixel G and the blue sub-pixel B will not transmit light even if the green sub-pixel G and the blue sub-pixel B are driven.

In this case, the display device according to the embodiment of the present disclosure can display the cyan part, green part and blue part of the frame of image in the first color field of each frame, and display the red part of the frame of image in the second color field, thus realizing a FSC display of two color fields. Even if a color break up phenomenon occurs in the display device according to the embodiment of the present disclosure, the cyan part, the green part and the blue part all displayed in the first color field will not be dislocated with one another. Therefore, compared with the FSC display of three color fields of the existing FSC liquid crystal display, the display device according to the embodiment of the present disclosure may eliminate the color break up phenomenon to a certain extent.

On the other hand, in the existing FSC display of three color fields, each frame of image is divided into three color fields. In this case, if the liquid crystal display needs to display at the refresh rate of 60 Hz, the practical refresh rate of the liquid crystal display should reach 180 Hz. In contrast, the display device according to the embodiment of the present disclosure can realize a FSC display of two color fields, each frame of image being divided into two color fields. If the frame of image needs to be displayed at the refresh rate of 60 Hz, the practical refresh rate only needs 120 Hz. Therefore, the display device according to the embodiment of the present disclosure has lower requirements for the refresh rate and response speed (response time) of liquid crystals, so that the display device according to the embodiment of the present disclosure is lower in cost, and may be implemented more easily in multiple patterns of IPS, VA, TN and the like.

Moreover, compared with embodiment I, color display based on four primary colors, including cyan, green, blue and red, can be also realized through the driving method according to this embodiment. Moreover, in the first color field, it is unnecessary to turn on the red light source, so that the power consumption of the backlight module can be further reduced, and the loss of red light can be reduced also.

It should be noted that, the sequence of the first color field and the second color field in the frame of image should be not restricted as that in this embodiment. When the frame of image is displayed, the first color field may be displayed first, and then the second color field is displayed, or alternatively, the second color field may be displayed first, and then the first color field is displayed.

### Embodiment III

The embodiment of the present disclosure provides a common (non-FSC) display device, including the backlight module according to embodiment I and embodiment II, and a common liquid crystal module. The liquid crystal module includes a plurality of pixel units, each pixel unit including a red sub-pixel, a green sub-pixel and a blue sub-pixel. In this arrangement, a red filter layer is arranged in the red sub-pixel, a green filter layer is arranged in the green sub-pixel, and a blue filter layer is arranged in the blue sub-pixel.

That is to say, the backlight module according to embodiment I and embodiment II is applied to the display device of a non-FSC display mode. Of course, the red light source and the blue light source in the backlight module do not have to be independently driven respectively.

Although the backlight module in this embodiment is not used for realizing the FSC display of two color fields, compared with the existing display device of the non-FSC display mode, the backlight module in this embodiment may still only use the red light source and the blue light source to emit white light, without a green light source, so that the effects of reducing the power consumption and realizing high color domain display are achieved.

Although the implementations disclosed by the present disclosure are described above, the contents are implementations merely adopted to facilitate understanding of the present disclosure, rather than limiting the present disclosure. Any skilled in the art to which the present disclosure pertains may make any modifications and variations on the implementation form and detail without departing from the disclosed spirit and scope of the present disclosure, but the patent protection scope of the present disclosure shall be subject to the scope defined by the appended claims.

1. A backlight module, including a first color light source, a second color light source, and third color fluorescent powder arranged around the first color light source or the second color light source, wherein the energy level of the first color or the second color is higher than that of the third color.

2. The backlight module according to claim 1, wherein the first color light source is a red light source, the second color light source is a blue light source, and the third color fluorescent powder is green fluorescent powder arranged around the blue light source.

3. The backlight module according to claim 2, wherein the green fluorescent powder is sulfide fluorescent powder, aluminate fluorescent powder, phosphate fluorescent powder, borate fluorescent powder, silicate fluorescent powder or nitrogen oxide fluorescent powder.

4. The backlight module according to claim 1, wherein the first color light source and the second color light source are driven independently.

5. The backlight module according to claim 4, wherein the backlight module further includes a first driver connected with the first color light source, and a second driver connected with the second color light source.

6. The backlight module according to claim 1, wherein the first color light source and the second color light source are light emitting diodes.

7. The backlight module according to claim 1, wherein the backlight module is a side-type backlight module or a direct-lit backlight module.

8. A display device, including a liquid crystal module and a backlight module,
wherein the liquid crystal module includes a plurality of pixel units, each pixel unit including a transparent sub-pixel, a green sub-pixel and a blue sub-pixel;
a transparent filter layer or no filter layer is arranged in the transparent sub-pixel, a green filter layer is arranged in the green sub-pixel, and a blue filter layer is arranged in the blue sub-pixel; and
the backlight module includes a red light source, a blue light source, and green fluorescent powder arranged around the blue light source, the red light source and the blue light source being driven independently.

9. A driving method for driving the display device according to claim 8, comprising:
in a first color field, turning on the blue light source in the backlight module to drive the transparent sub-pixel, the green sub-pixel and the blue sub-pixel of each pixel unit in the liquid crystal module; and
in a second color field, turning on the red light source in the backlight module to drive the transparent sub-pixel of each pixel unit in the liquid crystal module;
wherein the first color field and the second color field form a frame of image displayed by the display device.

10. The driving method according to claim 9, wherein in a first color field, when the blue light source in the backlight module is turned on, the red light source in the backlight module is also turned on.
